(19) United States
(12) Patent Application Publication
(10) Pub. No.: US 2025/0196342 A1
(43) Pub. Date: Jun. 19, 2025

(54) METHOD, COMPUTER PROGRAM, AND APPARATUS FOR CONTROLLING A PLURALITY OF JOINTS OF A ROBOT BASED ON A DESIRED JOINT STATE

(71) Applicant: Sony Group Corporation, Tokyo (JP)

(72) Inventors: Seyed Sina MIRRAZAVI SALEHIAN, Morges (CH); Thomas VAN DE WIEL, Zurich (CH)

(21) Appl. No.: 18/847,257

(22) PCT Filed: Mar. 23, 2023
(86) PCT No.: PCT/EP2023/057550

§ 371 Date: Sep. 15, 2024

(30) Foreign Application Priority Data
Mar. 30, 2022 (EP) 22165302.5

(51) Int. Cl. B25J 9/16

(52) U.S. Cl. CPC B25J 9/1651; B25J 9/1653

(57) ABSTRACT

Examples relate to a method, a computer program, and an apparatus for controlling a plurality of joints of a robot based on a desired joint state. The method for controlling a plurality of joints of a robot based on a desired joint state comprises obtaining information on the desired joint state; obtaining information on a current joint state; filtering the desired joint state based on the information on the current joint state and based on state constraints of the robot to obtain information on a filtered desired joint state, wherein the filtered desired joint state complies to the state constraints; and providing the information on the filtered desired joint states to control the joints of the robot.

### FIELD

Examples relate to a method, a computer program, and an apparatus for controlling a plurality of joints of a robot based on a desired joint state, more particularly, but not exclusively, to a concept for a real-time feasibility filter for revolute and prismatic actuators in robotics systems.

### BACKGROUND

Robotic systems are used to fulfill complex motions and are required to operate efficiently. A robot may comprise a plurality of joints, such as prismatic and revolute joints, which are coordinated during operation. In robotic systems, many dynamic applications such as reaching, grabbing, and placing objects require accurate motion planning and dynamic motor control. Devising motion planning strategies to offer more robustness in the face of imprecise sensing and actuation is important. To this end, a motion planner may generate desired robot motion with respect to the latest state of the environment. On top of this, the generated motion must be feasible for the robot to follow. The feasibility is defined at kinematic (e.g. position and velocity) and dynamic levels (e.g. acceleration and jerk) and hence a generated motion must respect both levels to be called feasible. Operating an actuator beyond its limits can cause irreversible damage to both the actuator itself and the environment. It is not always possible to address the actuators' kinematic and dynamic limitations at the motion planning level due to limitations in the available computational resources. Moreover, it might not be enough to satisfy the state constraints at each level separately as one cannot change the position, velocity, and acceleration instantly due to the jerk limits.

### SUMMARY

Examples are based on the finding that a feasibility filter can be implemented, which allows filtering desired states so to comply with given kinematic and dynamic constraints. Examples may provide a computationally efficient method comprising modulating a desired robot's motion in such a way that the kinematic and dynamic constraints of the actuators are satisfied.

This method may be integrated into existing motion control approaches and may modulate a desired robot's motion in dynamic environments, where the robot must react to dynamic perturbations online.

An example relates to a method for controlling a plurality of joints of a robot based on a desired joint state. The method comprises obtaining information on the desired joint state and obtaining information on a current joint state. The method further comprises filtering the desired joint state based on the information on the current joint state and based on state constraints of the robot to obtain information on a filtered desired joint state. The filtered desired joint state complies to the state constraints. The method further comprises providing the information on the filtered desired joint states to control the joints of the robot. The filtering of the desired joint states may enable a real-time or near real-time processing to obtain filtered desired joint states, which comply to the state constraints of the robot.

The filtering of the desired state may be based on reducing a difference between the filtered desired state and the desired state considering the state constraints. Therewith, a deviation from the desired state and an actual or current state may efficiently be reduced.

For example, the filtering may be based on minimizing a difference between the filtered desired state and the desired state considering the state constraints. The filtered desired state may hence be optimum in view of given actual and desired states of the robot within boundaries given by the constraints.

In further examples, the difference may be determined by a sum or a weighted sum of the differences between the desired joint state and the filtered desired joint state in terms one or more of location or position of the joint, a velocity of the joint, an acceleration of the joint, a jerk of the joint, and/or one or more higher order derivatives of the location or position. Examples may take kinematic and dynamic constraints into account.

For example, the difference may be a mean-square error or a weighted mean-square error between the filtered desired state and the desired state considering the state constraints. Examples may implement a mean-square error filter for the desired joint states and therewith provide optimum or near optimum filtered joint states for given actual states and state constraints.

In implementations some examples may use filtering, which comprises determining filter rules for each of the plurality of joints separately. This may enable parallel filtering for the plurality of joints.

Furthermore, at least in some examples the filtering may be further based on avoiding an ultimate infeasible state of the robot. An ultimate infeasible state is a state, which may not violate any constraints at the very moment, however due to the kinematic and dynamic state an infeasible state will result in the future. An example of an ultimate infeasible state is a state in which a velocity is too high at a given position to avoid a violation of a position constraint, even when applying a maximum deceleration. Therewith examples may take future state constraints into account when determining current states. The avoiding of the ultimate infeasible state may be based on analyzing an effect of a filtered desired jerk on future states. That way, examples may also enable future state constraint compliance.

The filtering may be further based on coupling effects between the joints of the robot and/or non-linear dynamics of the joints of the robot in further examples. Examples may therefore also take into account mutual coupling effects or non-linearities among the joints of the robot.

The current, the desired and the filtered desired joint states may comprise one or more of information on a location or position of the joint, a velocity of the joint, an acceleration of the joint, a jerk of the joint, and/or one or more higher order derivatives of the location or position. Examples may provide filtered kinematic and dynamic desired states. Hence, the current and the filtered desired joint states may comprise information on a location or position of the joint, a velocity of the joint, an acceleration of the joint and a jerk of the joint. In some examples the desired joint state may comprise three or less elements of the group of information on a location or position of the joint, a velocity of the joint, an acceleration of the joint, a jerk of the joint, and/or one or more higher order derivatives of the location or position. The method may then further comprise predicting a desired joint state for a subsequent time interval based on the current and the desired joint state. The desired joint state for the subsequent time interval may comprise predicted information on one or more elements of the group of a location or position of the joint, a velocity of the joint, an acceleration of the joint, a jerk of the joint, and/or one or more higher order derivatives of the location or position. The filtering may then be based on the predicted desired joint state for the subsequent time interval.

The predicting of the desired joint state for the subsequent time interval may comprise using a parametric state estimation based on the desired joint state to obtain the predicted desired joint state for the subsequent time interval. Examples may provide an efficient way for predicting the desired joint states. The parametric state estimation may, for example, use a Sa-vitzky-Golay algorithm.

Furthermore, in examples the filtering may be based on state constraints, which are based on a number of multiple subsequent time intervals. Therewith, examples may allow for a prediction horizon. The number of subsequent intervals may be configured to allow stopping a motion of a joint based on a maximum deceleration constraint of the joint. Examples may hence allow stopping of a motion within the prediction horizon. For example, the number of time intervals may further depend on one or more of a location or position of the joint, a velocity of the joint, a maximum admissible acceleration and/or jerk of the joint. Therewith, kinematic and dynamic constraints may determine the prediction horizon in examples. In general, the state constraints may comprise kinematic and dynamic constraints of the joint.

A further example is a computer program having a program code for performing any one of the methods described herein, when the computer program is executed on a computer, a processor, or a programmable hardware component.

Another example is an apparatus for controlling an automated device comprising a control unit for performing one of the methods described herein. Yet another example is an automated device, a robot, or a controller for a robot, e.g. an industrial robot, comprising an example of the apparatus.

### BRIEF DESCRIPTION OF THE FIGURES

Some examples of apparatuses and/or methods will be described in the following by way of example only, and with reference to the accompanying figures, in which

FIG. 1 shows a block diagram of a flow chart of an example of a method for controlling a plurality of joints of a robot based on a desired joint state;

FIG. 2 shows a block diagram of an example of an apparatus for controlling a plurality of joints of a robot and an example of a robot;

FIG. 3 illustrates another example of a robot;

FIG. 4 shows examples of motion control architectures for controlling robotic systems;

FIG. 5 depicts an illustrative example of an ultimate unfeasible state using kinematic and dynamic diagrams;

FIG. 6 illustrates examples of proposed motion control architectures using a feasibility filter;

FIG. 7 shows a block diagram of a flow chart of an example of a feasibility filter;

FIG. 8 illustrates example timelines of kinematic and dynamic parameters in a first scenario with three reference steps;

FIG. 9 illustrates example timelines of kinematic and dynamic parameters in a second scenario with a sinusoidal reference; and

FIG. 10 illustrates example timelines of kinematic and dynamic parameters in a third scenario with a step reference to a position limit.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

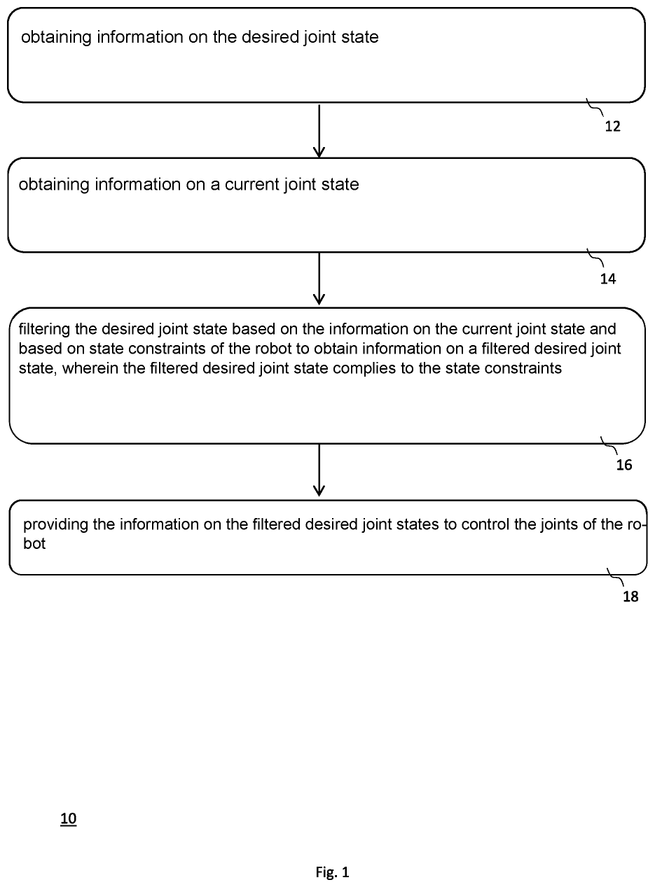

FIG. 1 shows a block diagram of a flow chart of an example of a method 10 for controlling a plurality of joints of a robot based on a desired joint state. The method 10 comprises obtaining 12 information on the desired joint state and obtaining 14 information on a current joint state. The method 10 further comprises filtering 16 the desired joint state based on the information on the current joint state and based on state constraints of the robot to obtain information on a filtered desired joint state. The filtered desired joint state complies to the state constraints. The method 10 further comprises providing 18 the information on the filtered desired joint states to control the joints of the robot.

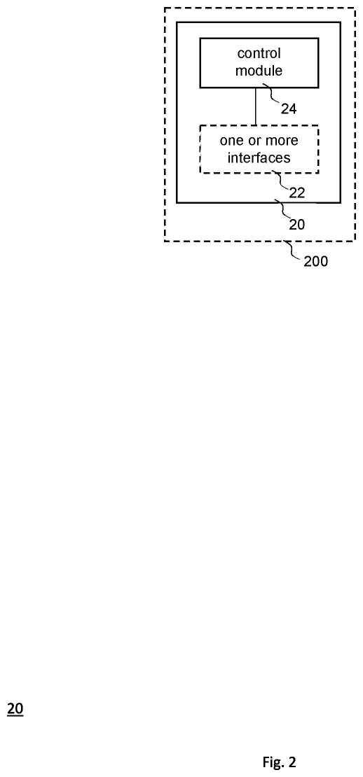

FIG. 2 shows a block diagram of an example of an apparatus 20 for controlling a plurality of joints of a robot and an example of a robot 200. The apparatus 20 for controlling the plurality of joints of the robot 200 comprises a control module for performing one of the methods described herein. FIG. 2 further illustrates an example of a robot 200 or controller for a robot 200 (shown in broken lines as it is optional from the perspective of the apparatus 20) comprising an example of the apparatus 20.

As further illustrated in FIG. 2 the apparatus 20 may comprise one or more interfaces 22, which are coupled to the respective control module or unit 24. The one or more interfaces 22 may correspond to one or more inputs and/or outputs for receiving and/or transmitting information, which may be in digital (bit) values according to a specified code, within a module, between modules or between modules of different entities. For example, an interface 22 may comprise interface circuitry configured to receive and/or transmit information. In examples an interface 22 may correspond to any means for obtaining, receiving, transmitting or providing analog or digital signals or information, e.g. any connector, contact, pin, register, input port, output port, conductor, lane, etc., which allows providing or obtaining a signal or information. An interface 22 may be configured to communicate (transmit, receive, or both) in a wireless or wireline manner and it may be configured to communicate, i.e. transmit and/or receive signals, information with further internal or external components. The one or more interfaces 22 may comprise further components to enable communication in a mobile communication system, such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly, adapted radio frequency components, etc.

The control module 24 may be implemented using one or more processing units, one or more processing devices, any means for processing, such as a processor, a computer or a programmable hardware component being operable with accordingly adapted software. In other words, the described function of the control/processing module 24 may as well be implemented in software, which is then executed on one or more programmable hardware components. Such hardware components may comprise a general-purpose processor, a Digital Signal Processor (DSP), a micro-controller, etc. A further example is an automated device 200, e.g. an automated/autonomous vehicle or an industrial robot, comprising an example of the apparatus 20.

Examples may enable a real-time feasibility filter for revolute and prismatic actuators in robotics systems. In this description the following terminology is used:
Task Space: The state of the end-effector of the robot.
Joint Space: The state of each joint of the robot.
States: Including but not limited to position, velocity, acceleration, jerk, and/or one or more higher order derivatives of the location or position of the end-effector or the joints at the task or joint-spaces; respectively.
Target state: A state in which the robot should be at the target time.
Desired state: A state in which the robot should be in one sample time.
Motion planner: An algorithm or a set of algorithms that plan the motion of the robot between the current and the target states.
Inverse kinematics: An algorithm or a set of algorithms that convert a task-space state to a corresponding joint-space state.
Tracking error: The difference between the desired and current state.
Infeasible state: A state which violates one or multiple constraints at position, velocity, acceleration, jerk levels, and/or a level of one or more higher order derivatives of the location or position.
Ultimate infeasible state:
   A state that is currently feasible but will ultimately violate position, velocity, or acceleration constraints due to jerk limits.

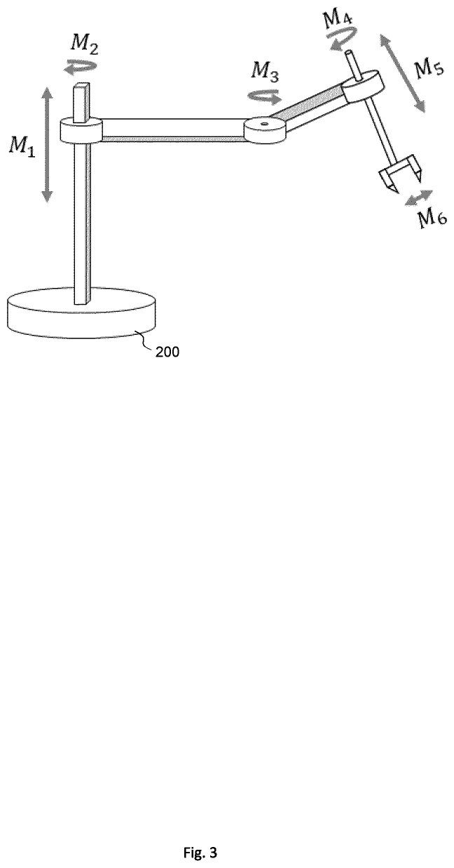

Given a fixed or moving target state, the goal of a motion-planner is to calculate the intermediate states that bring a robotic system, exemplified in FIG. 3, from its current state to the target state in real-time. FIG. 3 illustrates another example of a robot 200. The example robot 200 comprises a 6 degree of freedom robotic system. Each joint is equipped with one actuator. The actuators M_1, M_5 and M_6 are prismatic and M_2, M_3 and M_4 are revolute. The actuators are controlled, independently from the others, at the position level. An embedded low-level controller converts position commands to the desired torque such that the actuators move the joints to the desired position.

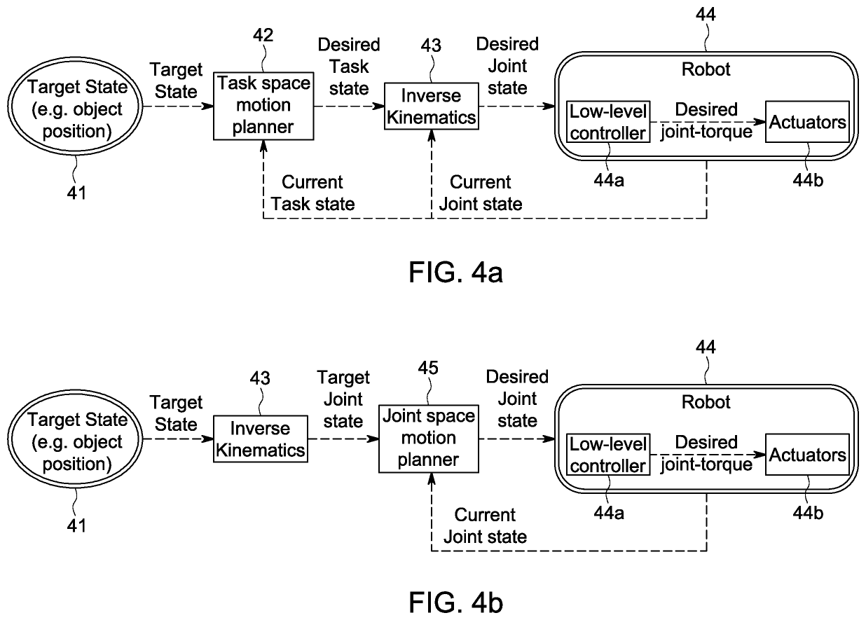

Planning the desired motion of a robotic system can be addressed at two distinct levels, i.e., at the task-space level, or at the joint-space level, which is further detailed in FIG. 4. FIG. 4 shows examples of motion control architectures for controlling robotic systems. At the top of FIG. 4 a target state is input 41, e.g. an object position. At the top, the desired motion (desired task state) is generated at the task space level by a task space motion planner 42, with respect to the target and the current states. Then the desired task-space value is translated into desired joint motions using inverse kinematics 43 based on current joint states, before being provided to the robot 44. The robot 44 uses a low-level controller 44a to generate the desired joint torque for the actuators 44b of the robot 44.

FIG. 4 shows an alternative architecture at the bottom. At the bottom the motion planner aims to directly generate the desired joint states with respect to the target and the current states. The target state is provided to the inverse kinematics 43 to obtain the target joint states, which are then provided to a joint space motion planner 45, which generates the desired joint state based on the current joint states. The desired joint states are then provided to the robot 44. The robot 44 again uses a low-level controller 44a to generate the desired joint torque for the actuators 44b of the robot 44.

To endow robotic systems with a capability to accomplish dynamic scenarios, the robot's motion should be regularly updated in a computationally efficient way and the desired states should satisfy the kinematic and the dynamics constraints of the actuators before being commanded to the robot. Hence, (i) the computation budget and (ii) the constraint satisfaction at the current and the future time steps are two key aspects in accomplishing dynamic scenarios.

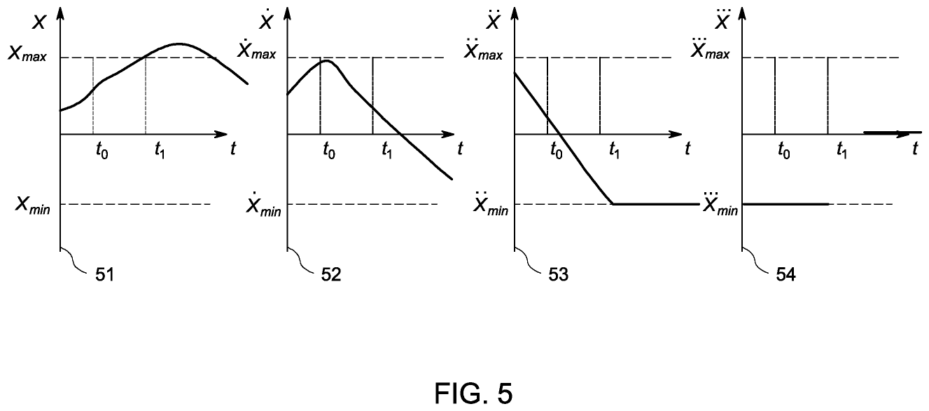

The command motion should be generated such that it satisfies the state constraints and also avoids the ultimate infeasible states, where the violation of the position or velocity constraints cannot be avoided with any feasible jerk value. An example of this scenario is illustrated in FIG. 5. FIG. 5 depicts kinematic and dynamic diagrams of an ultimate unfeasible state. FIG. 5 shows time diagram of a position x 51, a velocity \dot{x} 52, an acceleration \ddot{x} 53, and a jerk [symbol] 54 of a joint. The limits are indicated by the respective “min” and “max”-thresholds.

In this example, the state is feasible at t_0. However, as the state at the position level is near the upper limits and the velocity and the acceleration are also large positive values, there is no feasible jerk to avoid constraint violation at t_1. In the ultimate infeasible state shown in FIG. 5 a position constrain violation cannot be avoided due to the jerk limits.

A command should be regularly updated, in a computationally efficient way, to reflect the latest changes in the environment. As an industrial application, one can imagine a dynamic pick-and-place scenario where the robot must reach an object moving on a conveyor belt, pick it up and place it at the desired location. If the robot's motion is not updated regularly and in a computationally efficient way, there is a high chance of missing the object and failing the task. Another application could be human-robot collaborations at warehouses, where the robot should move an object with the guidance of an operator. Due to the inherent characteristic of this scenario, the motion of the robot cannot be planned beforehand, and it needs to be regularly updated with respect to the latest guidance of the operator.

Commanding the desired state which violates these constraints can result in poor tracking performance and can even cause irreversible damage to the actuators due to high torques generated by the low-level controller. Poor tracking performance can yield either overshooting or undershooting. An overshoot can be dangerous as the robot could get into a collision with the environment, e.g., the robot might hit the conveyer belt in the dynamic pick-and-place scenario. An undershoot is also not desirable as the robot might miss reaching a moving target.

To address this problem and to avoid ill-defined and infeasible motions, examples may use a computationally efficient algorithm to modulate the desired joint state of the robot such that it satisfies the kinematic and dynamic constraints of the actuators.

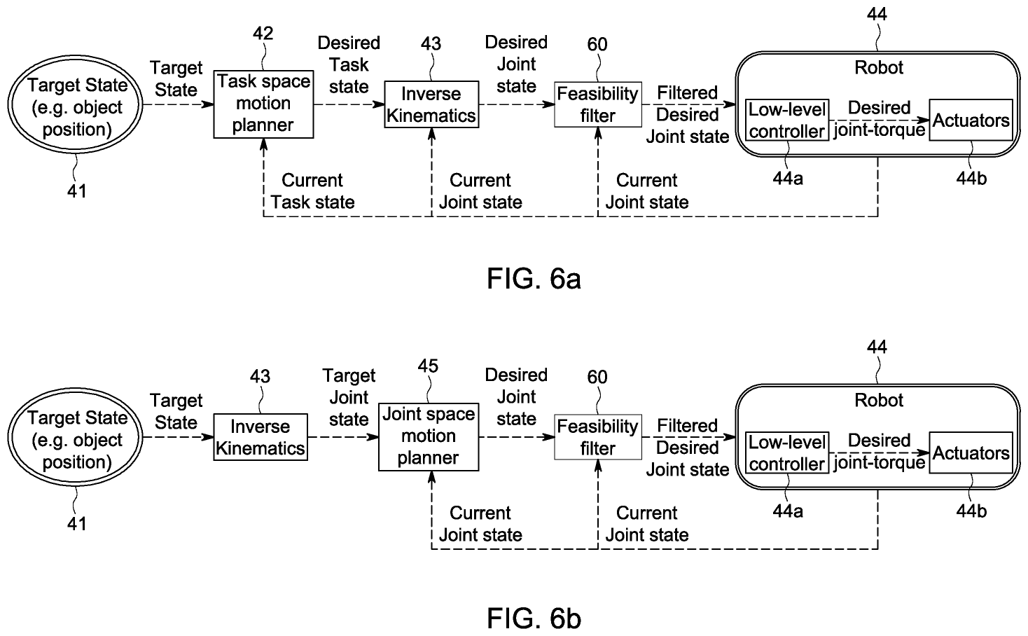

This can be achieved by the filtering 16 in FIG. 1, which can be realized by a feasibility filter block, which is detailed further in FIG. 6. FIG. 6 illustrates example motion control architectures similar to FIG. 4 with basically the same components except for an addition feasibility filter 60, as an implementation of the above apparatus 20 for carrying out the method 10. The feasibility filter 60 generates filtered desired joint states based on desired joint states and current joint states. The filtered desired joint states are then provided to the robot 44. As outlined in more detail with respect to FIG. 4 both architecture variants are conceivable in examples. For example, the motion is modulated such that the difference between the desired state and the filtered desired state is minimized while the filtered desired state satisfies all the state constraints. In examples, the filtering 16 of the desired state may be based on reducing or even minimizing a difference between the filtered desired state and the desired state considering the state constraints.

Removing unwanted components or features from a signal has extensively been studied in robotics and signal processing literature. However, the problem of modulating an online signal with respect to state constraints is a new field of research. Linear filters like low-pass, high-pass, band-pass filters, and notch filters have been broadly used to remove a certain frequency component from a signal. These filters can be designed to achieve maximally flat frequency response in Butterworth filter, the best approximation to the ideal response in Che-byshev filter, maximally flat phase delay in Bessel filter, and the steepest cutoff for a specified order and ripple in Elliptic filter. These filters can be used in both analogue systems as well as, due to computational efficiency, in real-time digital systems.

The second category of the smoothing filters includes parametric filters, which are mainly used in digital signal processing applications. Savitzky-Golay, Kalman and Wiener filters have been used extensively to smooth, predict and correct a sensory signal in real-time. The Savitzky-Golay algorithm filters a signal by fitting a low-degree polynomial to successive subsets of adjacent data points. The Wiener filter smooths a signal by minimizing the mean-square error between an original signal and the filtered one. Kalman filters are a group of algorithms to provide an accurate estimation of a single measurement by using a system's dynamic model and statistical noises. Even though these filters are computationally efficient and can be used in real-time applications, they can unfortunately not guarantee that the smoothed signal satisfies the state constraints at the current state, let alone to avoid ultimate infeasible states.

Another way to address the feasibility of a generated motion is to devise a motion planning algorithm that can directly consider the state constraints while computing a new intermediate state. Model predictive control (MPC) and optimal control are types of motion planning algorithms for robotic systems that explicitly consider constraints imposed on the system by solving a constrained optimization problem. The constraints are including, but are not limited to, the kinematic and dynamic constraints. Additionally, one can avoid harmful interactions of the system with its environment by defining collision constraints. MPC and optimal control are powerful techniques that solve the motion planning problem while guaranteeing the feasibility of the motion. However, depending on the size and complexity of the underlying optimization problem, significant computational resources are required, and solver times might be too high to be used for real-time closed-loop feedback control of the considered dynamic scenarios.

Examples may exploit the advantages of algorithms mentioned above to provide a computationally efficient method to modulate the desired joint state such that it satisfies the kinematic and dynamic constraints of the actuators in real-time applications. To reduce the computation time, examples may decouple motion-planning from the filtering 16 as illustrated in FIG. 6. Unlike Kalman filters, examples might not assume that the dynamics of the desired states are known beforehand but approximate it locally with a linear time-invariant system and update it in real-time. FIG. 6 illustrates a schematic of an example of a control architecture for controlling robotic systems with the feasibility filter 60.

Suppose a desired joint position at time t is available and denoted by x_{d}[t]∈ [symbol] ^{N}, where N is the number of joints, and the sampling time is Δt∈ [symbol] ⁺. The aim of the feasibility filter 60 illustrated in FIG. 6 is to calculate the filtered desired joint state x_{f}[t]∈ [symbol] ^{N} that satisfies the kinematic and dynamic constraints of the actuators and avoids ultimate infeasible states, i.e.

$${x}_{min} \leq {x}_{f} [ i ] \leq {x}_{max} , ∀ i ∈ t , … ∞ \qquad Equation 1$$

$$- {\dot{x}}_{max} \leq {\dot{x}}_{f} [ i ] \leq {\dot{x}}_{max} , ∀ i ∈ t , … ∞$$

$$- {\ddot{x}}_{max} \leq {\ddot{x}}_{f} [ i ] \leq {\ddot{x}}_{max} , ∀ i ∈ t , … ∞$$

$$- {{x}^{...}}_{max} \leq {{x}^{...}}_{f} [ i ] \leq {{x}^{...}}_{max} , ∀ i ∈ t , … ∞ ,$$

where the desired acceleration, velocity, and position of the actuator at time [t] is computed according to

$${\ddot{x}}_{f} [ i ] = {\ddot{x}}_{f} [ i - 1 ] + {{x}^{...}}_{f} [ i ] Δ t \qquad Equation 2$$

$${\dot{x}}_{f} [ i ] = {\dot{x}}_{f} [ i - 1 ] + {\ddot{x}}_{f} [ i - 1 ] Δ t + \frac{1}{2} {{x}^{...}}_{f} [ i ] Δ {t}^{2}$$

$${x}_{f} [ i ] = {x}_{f} [ i - 1 ] + {\dot{x}}_{f} [ i - 1 ] Δ t + \frac{1}{2} {\ddot{x}}_{f} [ i - 1 ] Δ {t}^{2} + \frac{1}{6} {{x}^{...}}_{f} [ i ] Δ {t}^{3} ,$$

respectively. The current, the desired and the filtered desired joint states may comprise one or more of information on a location or position of the joint, a velocity of the joint, an acceleration of the joint, a jerk of the joint, and/or one or more higher order derivatives of the location or position. Moreover, the state constraints may comprise kinematic and dynamic constraints of the joint. Furthermore, a mean-square error between the desired joint state and the filter desired joint state may be minimized to maximize the chance of successful task accomplishment. For example, the difference between the desired state and the filtered desired state may be determined by a sum or a weighted sum of the differences between the desired joint state and the filtered desired joint state in terms one or more of location or position x of the joint, a velocity \dot{x} of the joint, an acceleration \ddot{x} of the joint, a jerk [symbol] of the joint and/or one or more higher order derivatives of the location or position. The difference may be a mean-square error or a weighted mean-square error between the filtered desired state and the desired state considering the state constraints. For example, the a weighted mean-square error (MSE) may be expressed as a sum of W_i*MSE(desired_state_i, filtered_state_i), wherein the W_i allow weighting the respective states variables.

To this end, the feasibility filter can be formulated as the following convex optimization problem:

$${min}_{{{x}^{…}}_{f} [ i ]} ( {\sum }_{i = t}^{t + K} {W}_{P}^{i} ‖ {x}_{f} [ i ] - {\hat{x}}_{d} [ i ] ‖ + {W}_{V}^{i} ‖ {\dot{x}}_{f} [ i ] - {\dot{\hat{x}}}_{d} [ i ] ‖ + {W}_{A}^{i} ‖ {\ddot{x}}_{f} [ i ] - {\ddot{\hat{x}}}_{d} [ i ] ‖ + {W}_{J}^{i} ‖ {{x}^{…}}_{f} [ i ] - {{\hat{x}}^{…}}_{a} [ i ] ‖ ) , \qquad Equation 3$$

where 0≤W_{P}ⁱ, W_{V}ⁱ, W_{A}ⁱ, W_{J}ⁱ and x_{f}[i], \dot{x}_{f}[i], \ddot{x}_{f}[i] are computed using Equation 2, and

$$\begin{matrix}{\ddot{x}}_{f} [ i ] = {\ddot{x}}_{f} [ i - 1 ] + {{x}^{…}}_{f} [ i ] Δ t , & {\ddot{x}}_{f} [ t ] = \ddot{x} [ t ]\end{matrix} \qquad Equation 4$$

$${\dot{x}}_{f} [ i ] = {\dot{x}}_{f} [ i - 1 ] + {\ddot{x}}_{f} [ i - 1 ] Δ t + \frac{1}{2} {{x}^{…}}_{f} [ i ] Δ {t}^{2} , \qquad {\dot{x}}_{f} [ t ] = \dot{x} [ t ]$$

$${x}_{f} [ i ] = {x}_{f} [ i - 1 ] + {\dot{x}}_{f} [ i - 1 ] Δ t + \frac{1}{2} {\ddot{x}}_{f} [ i - 1 ] Δ {t}^{2} + \frac{1}{6} {{x}^{…}}_{f} [ i ] Δ {t}^{3} , \qquad {x}_{f} [ t ] = x [ t ]$$

Subject to:

$${x}_{min} \leq {x}_{f} [ i ] \leq {x}_{max} , ∀ i ∈ t , … t + K \qquad Equation 5$$

$$- {\dot{x}}_{max} \leq {\dot{x}}_{f} [ i ] \leq {\dot{x}}_{max} , ∀ i ∈ t , … t + K$$

$$- {\ddot{x}}_{max} \leq {\ddot{x}}_{f} [ i ] \leq {\ddot{x}}_{max} , ∀ i ∈ t , … t + K$$

$$- {{x}^{…}}_{max} \leq {{x}^{…}}_{f} [ i ] \leq {{x}^{…}}_{max} , ∀ i ∈ t , … t + K$$

x is the current state of the robot and \hat{x}_{d} is the local approximation of the desired state and it is updated with respect to the desired joint states.

In equation 5 it would be more general to use \dot{x}ₘᵢₙ instead of −\dot{x}ₘₐₓ (asymmetrical limits). In practical applications symmetrical limits may apply. In some further applications, the above may be extended to systems, where

$${\dot{x}}_{min} \neq - {\dot{x}}_{max} .$$

For example, a rotational actuator coupled to some other components of a drive system could have such a constraint as well as rotational actuators with directional resistance. Such extension can be made to cases where the velocity, acceleration and jerk limits are asymmetric, however, for ease of derivation and representation of further results, symmetric constraints are assumed here.

If the desired velocity, acceleration, and jerk are available; x_{d} will simply be

$${\hat{x}}_{d} = {x}_{d} [ t ] \qquad Equation 6$$

$${\dot{\hat{x}}}_{d} = {\dot{x}}_{d} [ t ]$$

$${\ddot{\hat{x}}}_{d} = {\ddot{x}}_{d} [ t ]$$

$${{\hat{x}}^{…}}_{d} = {{x}^{…}}_{d} [ t ] .$$

However, in the most real-world applications, these values are not available. In this case, one could estimate them by using state estimation algorithms, e.g. parametric or non-parametric. Savitzky-Golay is an example for a parametric state estimation algorithm. An example of a non-parametric method is a moving average filter, which smooths short-term noises while high-lighting longer-term behavior. The main advantage of the moving average approach is the computation time. Another approach could use parametric and non-parametric regression methods approximated from a training dataset. Even though these methods can be used for estimating the state of the system, they might not be greatly generalized beyond the observed data points.

For example, the current and the filtered desired joint states may comprise information on a location or position of the joint, a velocity of the joint, an acceleration of the joint and a jerk of the joint. The desired joint state may comprise three or less elements of the group of information on a location or position of the joint, a velocity of the joint, an acceleration of the joint and a jerk of the joint. The method 10 may further comprise predicting a desired joint state for a subsequent time interval based on the current and the desired joint state. The desired joint state for the subsequent time interval may then comprise predicted information on one or more elements of the group of a location or position of the joint, a velocity of the joint, an acceleration of the joint and a jerk of the joint. The filtering 16 may be based on the predicted desired joint state for the subsequent time interval.

The predicting of the desired joint state for the subsequent time interval may comprise using a state estimation based on the desired joint state to obtain the predicted desired joint state for the subsequent time interval, for example, the state estimation uses a Savitzky-Golay algorithm.

K∈ [symbol] is an open parameter which specifies the safe motion horizon. It should be chosen such that the ultimate infeasible state cases can be avoided. The filtering 16 may hence be further based on avoiding an ultimate infeasible state of the robot. The avoiding of the ultimate infeasible state may be based on analyzing an effect of a filtered desired jerk on future states (determined by K). For example, the parameter K is to be selected as follows; proof will be provided subsequently. K may be calculated based on the most conservative number of the steps required to change the velocity sign.

$$K = \frac{{\ddot{x}}_{max} + \sqrt{{\ddot{x}}_{max}^{2} + 2 {{x}^{…}}_{max} {\dot{x}}_{max}}}{Δ t {{x}^{…}}_{max}} \qquad Equation 7$$

The ultimate infeasible state would only occur in four different scenarios:
1—If the velocity is positive, and the acceleration is also positive, then the velocity can untimely be infeasible.
2—If the velocity is negative, and the acceleration is also negative, the velocity can untimely be infeasible.
3—If the position is positive, and the velocity and acceleration are also positive, then the position can untimely be infeasible.
4—If the position is negative, and the velocity and acceleration are also negative, then the position can untimely be infeasible.

However, as the velocity, acceleration and jerk limits are assumed symmetric, one only needs to consider the following two scenarios and take the most conservative case.
1—If the velocity is positive, and the acceleration is also positive, then the velocity can untimely be infeasible.
2—If the position is positive, and the velocity and acceleration are also positive, then the position can untimely be infeasible.

To avoid the velocity constraint violation in the first case, one would like to find out how long it takes to reduce the acceleration from its maximum to zero. Given Equation 2, one can write:

$$0 = {\ddot{x}}_{max} - {{x}^{…}}_{max} K Δ t$$

Which one can calculate the safe motion horizon as:

$$K = \frac{{\ddot{x}}_{max}}{{{x}^{…}}_{max} Δ t}$$

To avoid the constraints' violation at the position level in the second scenario, one needs to calculate how long does it take to reduce the velocity from its maximum value to zero. Given Equation 2, one can write the following by using mathematical induction:

$$0 = {\dot{x}}_{max} - {\ddot{x}}_{max} K Δ t - \frac{{K}^{2}}{2} {{x}^{…}}_{max} Δ {t}^{2}$$

Which results in two solutions:

$$K = \frac{{\ddot{x}}_{max} \pm \sqrt{{\ddot{x}}_{max}^{2} + 2 {{x}^{…}}_{max} {\dot{x}}_{max}}}{Δ t {{x}^{…}}_{max}}$$

Given these three values, the most conservative safe horizon can be calculated as follows:

$$K = max ( \frac{{\ddot{x}}_{max} + \sqrt{{\ddot{x}}_{max}^{2} + 2 {{x}^{…}}_{max} {\dot{x}}_{max}}}{Δ t {{x}^{…}}_{max}} , \frac{{\ddot{x}}_{max} - \sqrt{{\ddot{x}}_{max}^{2} + 2 {{x}^{…}}_{max} {\dot{x}}_{max}}}{Δ t {{x}^{…}}_{max}} , \frac{{\ddot{x}}_{max}}{{{x}^{…}}_{max} Δ t} )$$

Which is

$$K = \frac{{\ddot{x}}_{max} + \sqrt{{\ddot{x}}_{max}^{2} + 2 {{x}^{…}}_{max} {\dot{x}}_{max}}}{Δ t {{x}^{…}}_{max}} .$$

In examples, the filtering 16 may be based on state constraints, which are based on a number of multiple subsequent time intervals. The number of subsequent intervals may be configured to allow stopping a motion of a joint based on a maximum deceleration constraint of the joint. As shown above the number of time intervals may further depend on one or more of a location or position of the joint, a velocity of the joint and a maximum admissible acceleration and jerk of the joint.

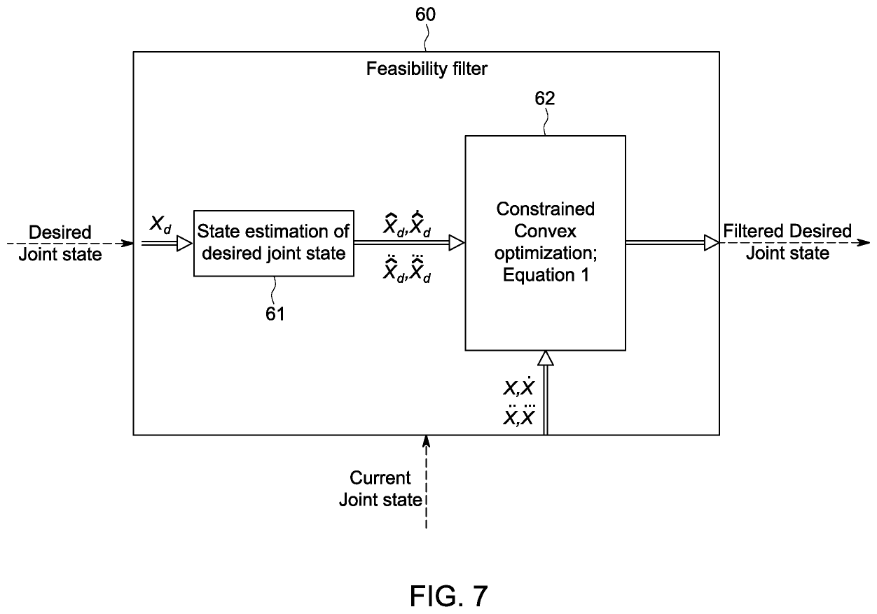

FIG. 7 shows a block diagram of a flow chart of an example of a feasibility filter 60. The feasibility filter 60 takes the (partial) desired joint state as input and then estimates or predicts 61 the full desired joint state as outlined above. The constrained convex optimization problem as outlined above in Equation 1 is then solved based on the current joint state and the constraints in block 62 to obtain the filtered desired joint state.

FIG. 7 illustrates the algorithm described by in Equation 1 to Fehler! Verweisquelle konnte nicht gefunden werden. The proposed algorithm is a computationally efficient linearly-constrained-convex optimization problem as the cost function (Equation 1) is only a function of N independent variables. Hence, instead of solving a single optimization problem with N*K independent variables, one can solve N independent optimization problems. In examples, the filtering 16 may comprise determining filter rules for each of the plurality of joints separately.

Moreover, the proposed algorithm in an example may handle ultimate infeasible states by analyzing the effect of the filtered desired jerk [symbol] _{f}[t] on the future states in Equation 5.

Even though the filtered desired joint states respect the kinematic and dynamic constraints, there are no guarantees that the robot would perfectly follow the filtered desired signals in case the system has non-negligible dynamics coupling effects between the different joints or loosely tuned low-level controller. Examples may handle this perturbation as the filtered desired state is updated at each cycle time. However, in cases the communication delay between the controller and the robot is significant and the robot's dynamic is highly nonlinear, Equation 4 needs to be replaced by

$$Equation 8$$

$$\begin{matrix}{x}_{f} [ i ] = f ( {x}_{f} [ t ] , {\dot{x}}_{f} [ t ] , {\ddot{x}}_{f} [ t ] , {{x}^{…}}_{f} [ t ] ) \\ + {\frac{\begin{matrix}\partial f ( {x}_{f} [ i - 1 ] , {\dot{x}}_{f} [ i - 1 ] , \\ {\ddot{x}}_{f} [ i - 1 ] , {{x}^{…}}_{f} [ i - 1 ] )\end{matrix} \vert}{\partial {x}_{f} [ i - 1 ]}}_{{x}_{f} [ t ] , {\dot{x}}_{f} [ t ] , {\ddot{x}}_{f} [ t ] , {{x}^{…}}_{f} [ t ]} ( {x}_{f} [ i - 1 ] - {x}_{f} [ t ] ) \\ + {\frac{\begin{matrix}\partial f ( {x}_{f} [ i - 1 ] , {\dot{x}}_{f} [ i - 1 ] , \\ {\ddot{x}}_{f} [ i - 1 ] , {{x}^{…}}_{f} [ i - 1 ] )\end{matrix} \vert}{\partial {\dot{x}}_{f} [ i - 1 ]}}_{{x}_{f} [ t ] , {\dot{x}}_{f} [ t ] , {\ddot{x}}_{f} [ t ] , {{x}^{…}}_{f} [ t ]} ( {\dot{x}}_{f} [ i - 1 ] - {\dot{x}}_{f} [ t ] ) \\ + {\frac{\begin{matrix}\partial f ( {x}_{f} [ i - 1 ] , {\dot{x}}_{f} [ i - 1 ] , \\ {\ddot{x}}_{f} [ i - 1 ] , {{x}^{…}}_{f} [ i - 1 ] )\end{matrix} \vert}{\partial {\ddot{x}}_{f} [ i - 1 ]}}_{{x}_{f} [ t ] , {\dot{x}}_{f} [ t ] , {\ddot{x}}_{f} [ t ] , {{x}^{…}}_{f} [ t ]} ( {\ddot{x}}_{f} [ i - 1 ] - {\ddot{x}}_{f} [ t ] ) \\ + {\frac{\begin{matrix}\partial f ( {x}_{f} [ i - 1 ] , {\dot{x}}_{f} [ i - 1 ] , \\ {\ddot{x}}_{f} [ i - 1 ] , {{x}^{…}}_{f} [ i - 1 ] )\end{matrix} \vert}{\partial {{x}^{…}}_{f} [ i - 1 ]}}_{{x}_{f} [ t ] , {\dot{x}}_{f} [ t ] , {\ddot{x}}_{f} [ t ] , {{x}^{…}}_{f} [ t ]} ( {{x}^{…}}_{f} [ i - 1 ] - {{x}^{…}}_{f} [ t ] )\end{matrix}$$

as the first order Taylor expansion of the robot dynamics x_{f}[t+1]=f(x_{f}[t], \dot{x}[t], \ddot{x}_{f}[t], [symbol] _{f}[t]). This dynamic can be either identified by parametric system identification algorithms or approximated by black-box deep learning models. Note that this does not come at the expense of higher computational complexity and the increased solver time as the first-order expansion is linear with respect to the decision variable. This scenario rarely occurs since almost all industrial robotic systems have low-level controllers that (i) eliminate coupling between the robot joints and (ii) reduce non-linear dynamics to linear dynamics. In these cases, the proposed filter can be implemented efficiently on the high-level control loop that provides references for the robot arm. The filtering 16 may hence be further based on coupling effects between the joints of the robot and/or non-linear dynamics of the joints of the robot.

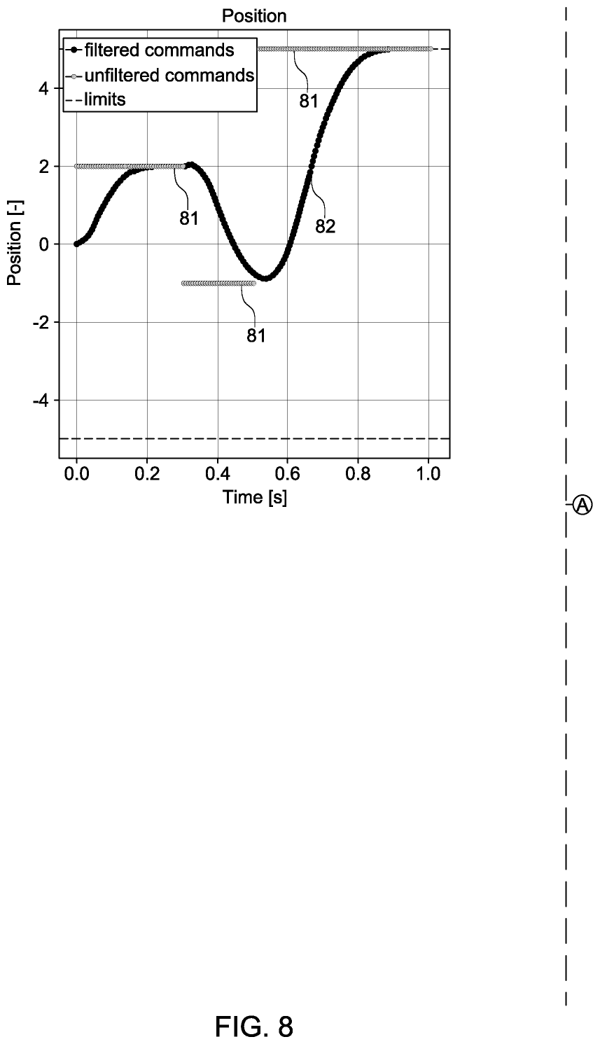

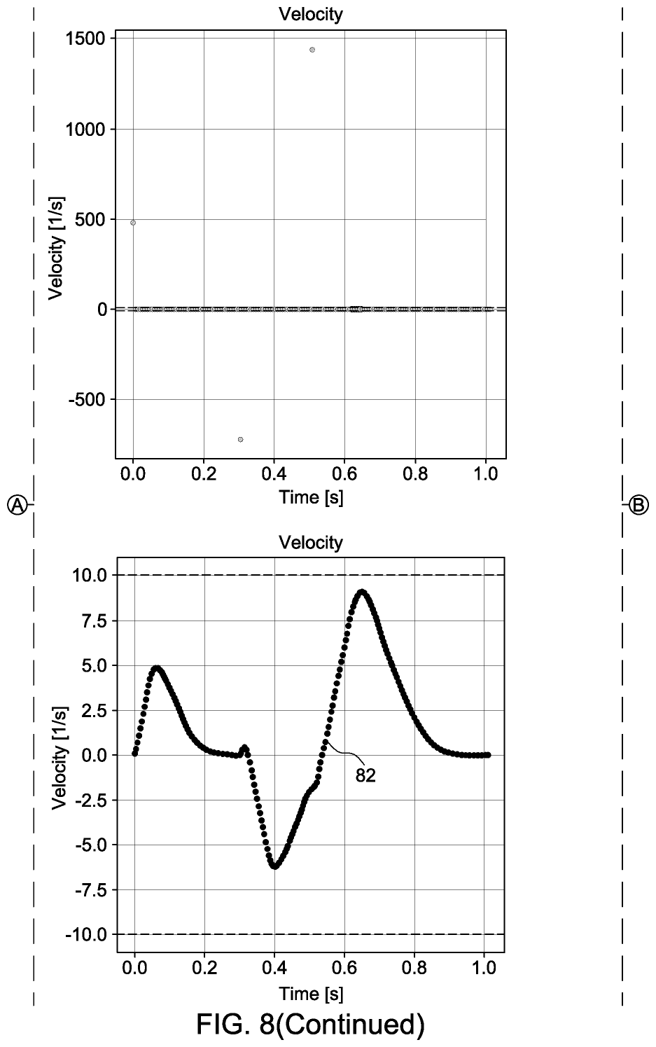

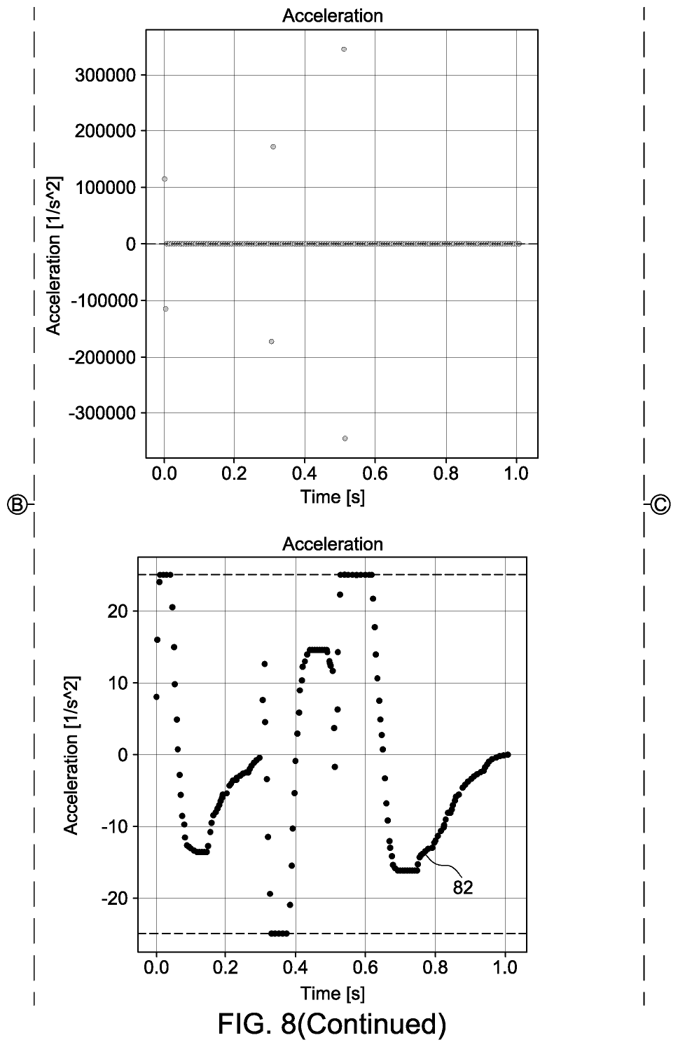

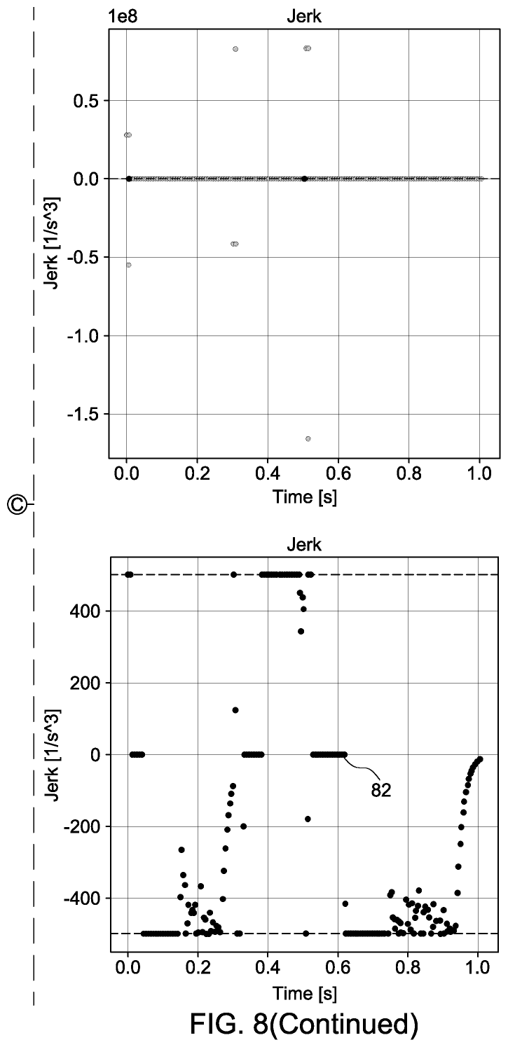

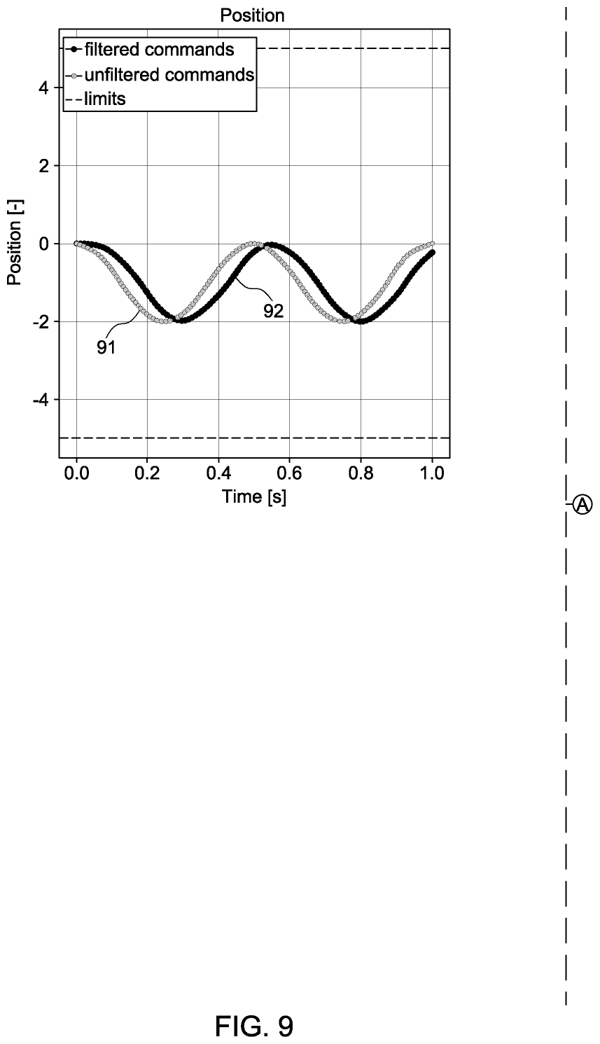

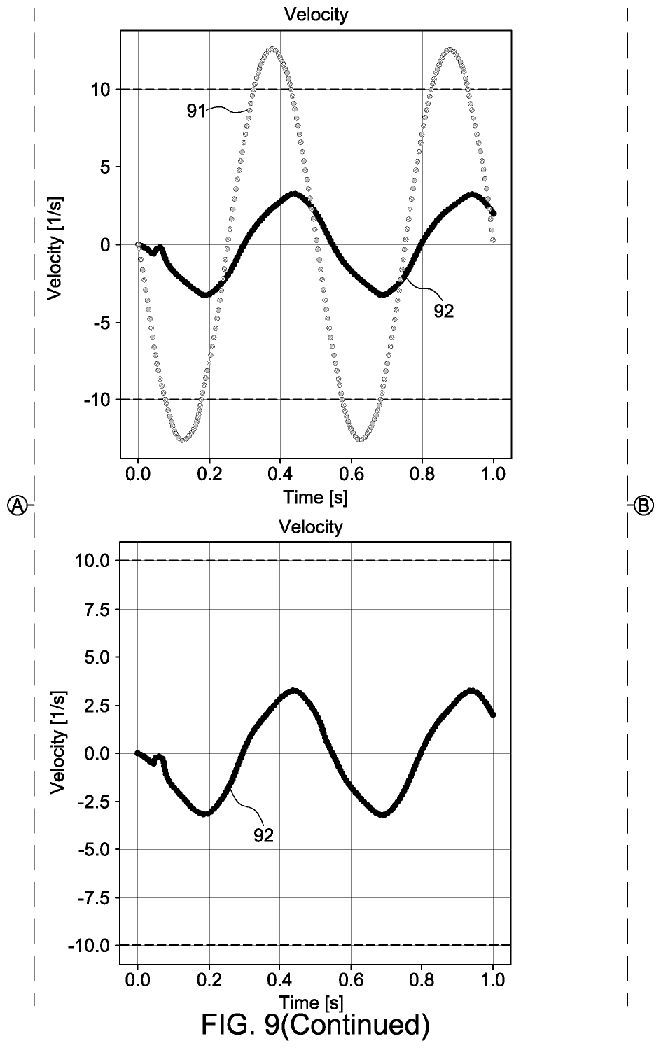

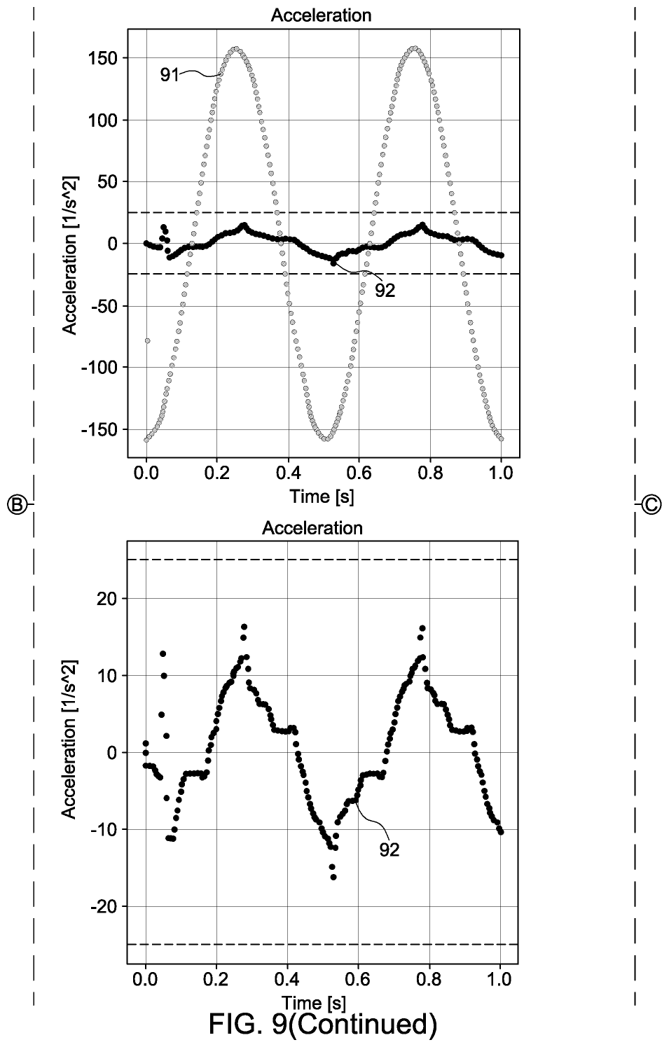

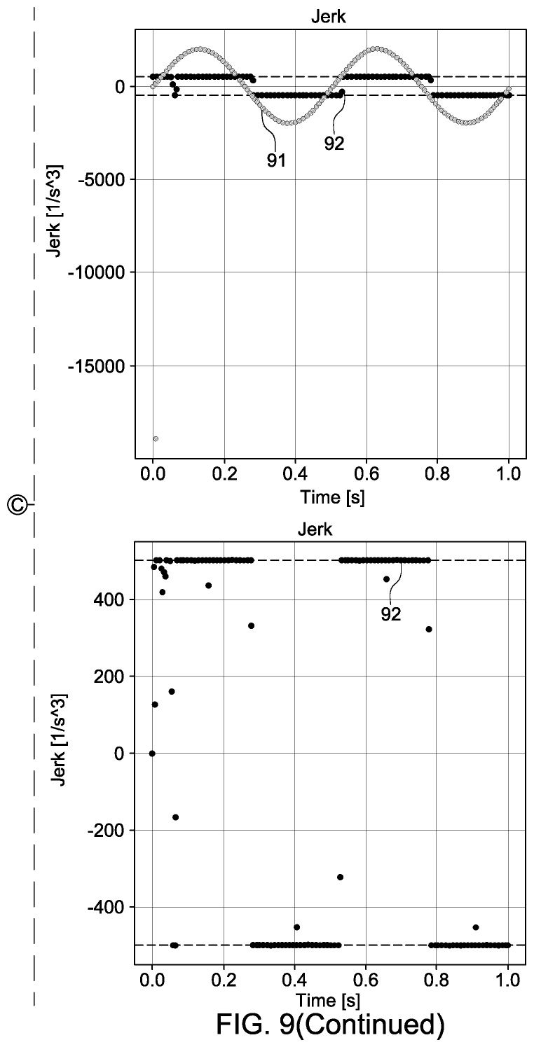

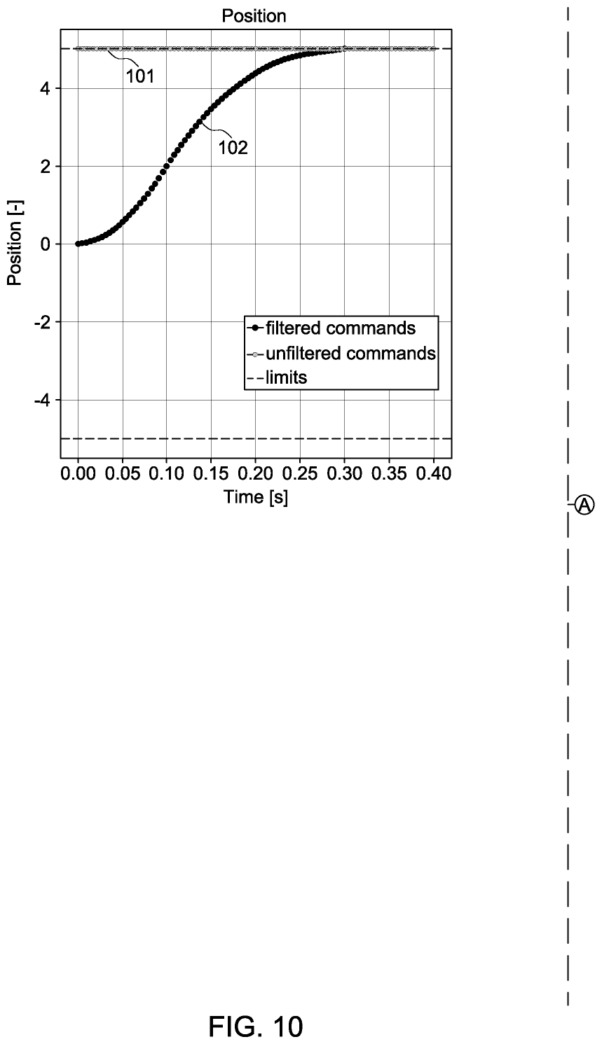

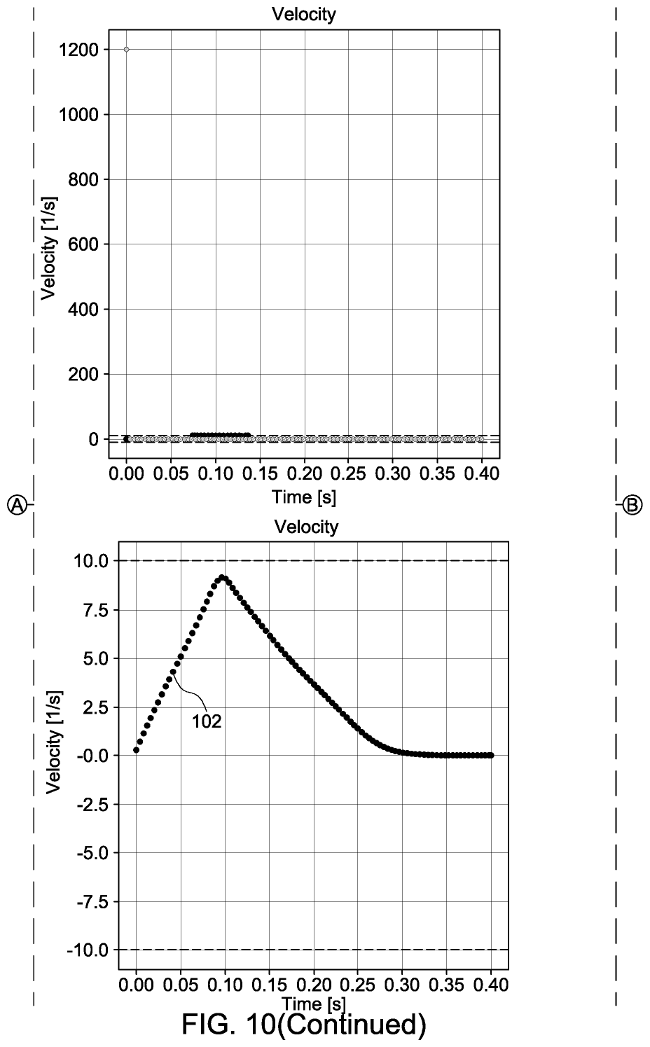

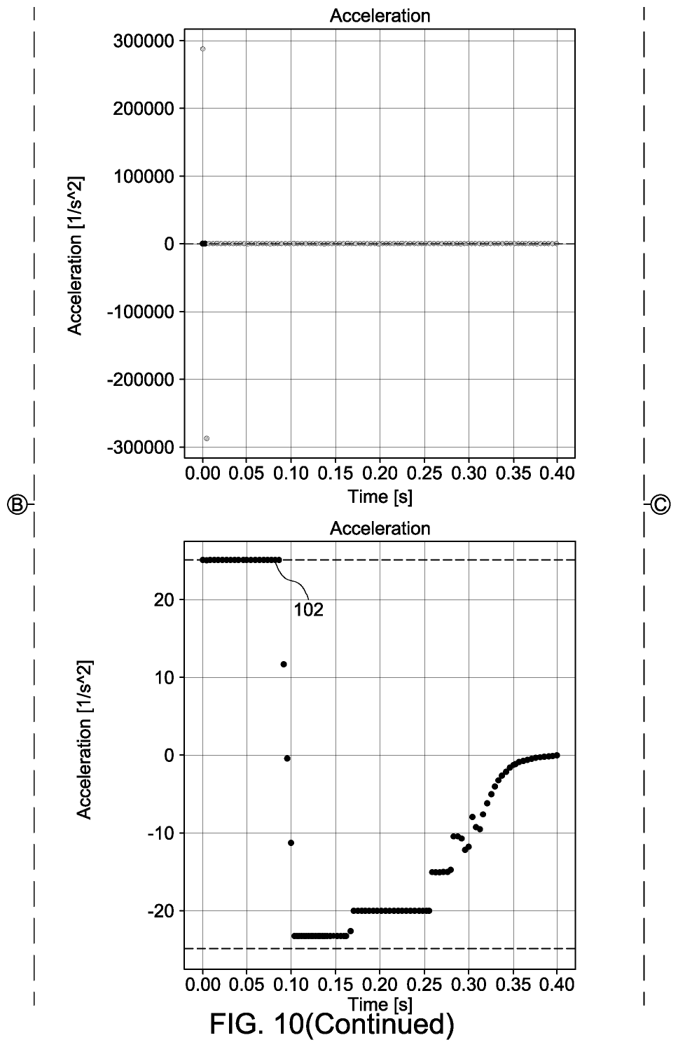

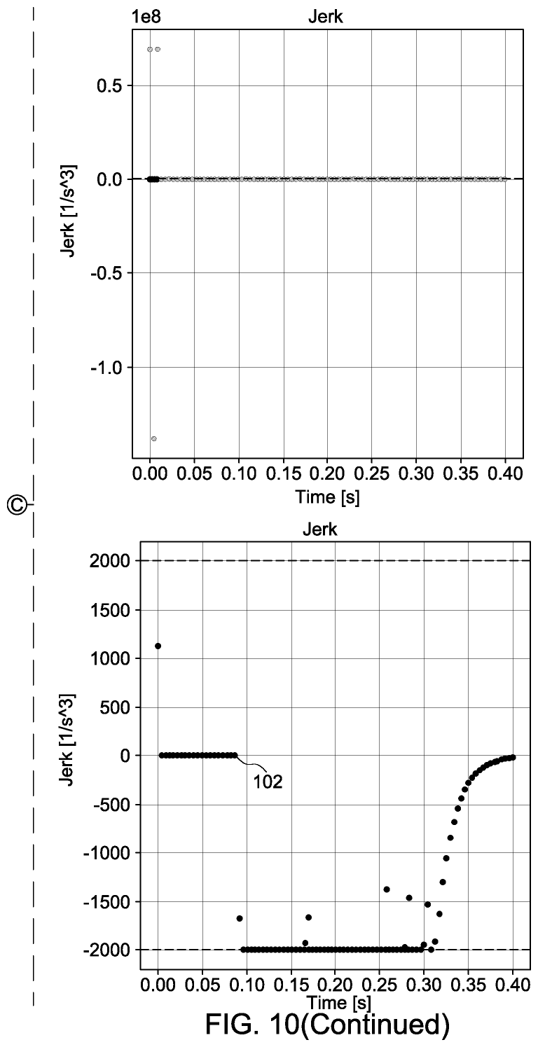

To provide more insight in the proposed feasibility filter, three detailed numerical examples will be presented in the sequel. FIG. 8 illustrates example timelines of kinematic and dynamic parameters in a first scenario, FIG. 9 illustrates example timelines of kinematic and dynamic parameters in a second scenario, and FIG. 10 illustrates example timelines of kinematic and dynamic parameters in a third scenario. FIGS. 8, 9, and 10 are structured in similar ways, with view charts depicting position, velocity, acceleration and jerk over time at the top. The position of the joint at the top of the figures always shows both the filtered and unfiltered position. The plots of the velocity, acceleration and jerk at the top show the unfiltered values and at the bottom the respective (zoomed) filtered values are shown.

In FIG. 8 to 10 the unfiltered position commands are shown at the top left as 81, 91, and 101 and the respective state variable limits are shown in dashed lines. The filtered position command, as well as the corresponding filtered velocity, acceleration, and jerk commands are shown as lines 82, 92, and 102. The FIG. 8 does not show the unfiltered velocity, acceleration, and jerk signals; these are only shown in FIG. 9. Numerical values for the three scenarios can be found in Table 1.

FIG. 8 show a three step reference scenario. The velocity, acceleration and jerk values are zoomed in at the bottom for better illustration. As it can be seen, even though the desired velocity, acceleration and the jerk exceed the maximum values, the filtered values are all respecting the constraints.

In the first example in FIG. 8, three step reference commands are applied to the system:

$${x}_{d} = \{ \begin{matrix}2 & t ∈ [ 0 , 0.3 [ \\ - 1 & t ∈ [ 0.3 , 0.5 [ \\ 5 & t ∈ [ 0.5 , 1. ]\end{matrix}$$

It can be seen that the step commands cannot be followed by the robot without violating the velocity, acceleration, and jerk constraints. The filtered commands, on the other hand, show convergence towards the commanded positions, while simultaneously avoiding violation of the state constraints.

In the second example in FIG. 9, the commanded positions are smooth and follow a sinusoidal motion pattern with amplitude 1 making two full oscillations in is:

$${x}_{d} ( t ) = cos ( 4 π t ) - 1$$

By looking at the jerk plot, one can see that the system is operated at its jerk limits, which is causing a delayed tracking behavior on the position level. Note that this is the best possible to track the position reference under the given state constraints and the cost function given in Fehler! Verweisquelle konnte nicht gefunden werden. The unfiltered commands clearly violate the state constraints.

FIG. 9 shows scenario 2 with a sinusoidal reference. The velocity, acceleration and jerk values are zoomed in at the bottom for better illustration. As it can be seen, even though the desired velocity, acceleration and the jerk exceed the maximum values, the filtered values are all respecting the constraints.

In the third example illustrated in FIG. 10, a situation is considered in which the commanded position is located at the upper position constraint: x_{d}(t)=5. Evidently, this position can only be reached when the velocity, acceleration and jerk are all zero at the moment the position is reached. Should any of these states be larger than zero, the position constraint would be violated. Should any of the states be smaller than zero, the commanded position cannot be reached. Finally note that by using the filter, all constraints are satisfied.

FIG. 10 show scenario 3 with a step reference to position limit. The velocity, acceleration and jerk values are zoomed in at the bottom for better illustration. As it can be seen, even though the desired velocity, acceleration and the jerk exceed the maximum values, the filtered values are all respecting the constraints.

TABLE 1

| | Position | Velocity | Acceleration | Jerk |
|---|---|---|---|---|
| | limit | limit | limit | limit |
| Scenario | [—] | [1/s] | [1/s\hat{ }2] | [1/s\hat{ }3] |
| 1 | 5 | 10 | 25 | 500 |
| 2 | 5 | 10 | 25 | 500 |
| 3 | 5 | 10 | 25 | 2000 |

In the following some examples are summarized:

(1) A method for controlling a plurality of joints of a robot based on a desired joint state, the method comprising obtaining information on the desired joint state; obtaining information on a current joint state; filtering the desired joint state based on the information on the current joint state and based on state constraints of the robot to obtain information on a filtered desired joint state, wherein the filtered desired joint state complies to the state constraints; and providing the information on the filtered desired joint states to control the joints of the robot.

(2) The method of (1), wherein the filtering of the desired state is based on reducing a difference between the filtered desired state and the desired state considering the state constraints.

(3) The method of one of (1) or (2), wherein the filtering is based on minimizing a difference between the filtered desired state and the desired state considering the state constraints.

(4) The method of one of (2) or (3), wherein the difference is determined by a sum or a weighted sum of the differences between the desired joint state and the filtered desired joint state in terms one or more of location or position of the joint, a velocity of the joint, an acceleration of the joint, a jerk of the joint, and/or a higher order derivative of the location or position.

(5) The method of one of (2) to (4), wherein the difference is a mean-square error or a weighted mean-square error between the filtered desired state and the desired state considering the state constraints.

(6) The method of one of (1) to (5), wherein the filtering comprises determining filter rules for each of the plurality of joints separately.

(7) The method of one of (1) to (6), wherein the filtering is further based on avoiding an ultimate infeasible state of the robot.

(8) The method of (7), wherein the avoiding of the ultimate infeasible state is based on analyzing an effect of a filtered desired jerk on future states.

(9) The method of one of (1) to (8), wherein the filtering is further based on coupling effects between the joints of the robot and/or non-linear dynamics of the joints of the robot.

(10) The method of one of (1) to (9), wherein the current, the desired and the filtered desired joint states comprise one or more of information on a location or position of the joint, a velocity of the joint, an acceleration of the joint, and/or a jerk of the joint, and/or a higher order derivative of the location or position.

(11) The method of one of (1) to (9), wherein
the current and the filtered desired joint states comprise information on a location or position of the joint, a velocity of the joint, an acceleration of the joint and a jerk of the joint, and wherein the desired joint state comprises three or less elements of the group of information on a location or position of the joint, a velocity of the joint, an acceleration of the joint and a jerk of the joint, and
wherein the method further comprises predicting a desired joint state for a subsequent time interval based on the current and the desired joint state, wherein the desired joint state for the subsequent time interval comprises predicted information on one or more elements of the group of a location or position of the joint, a velocity of the joint, an acceleration of the joint and a jerk of the joint, and
wherein the filtering is based on the predicted desired joint state for the subsequent time interval.

(12) The method of (11), wherein the predicting of the desired joint state for the subsequent time interval comprises using a state estimation based on the desired joint state to obtain the predicted desired joint state for the subsequent time interval.

(13) The method of (12), wherein the state estimation uses a Savitzky-Golay algorithm.

(14) The method of one of (1) to (13), wherein the filtering is based on state constraints, which are based on a number of multiple subsequent time intervals.

(15) The method of (14), wherein the number of subsequent intervals is configured to allow stopping a motion of a joint based on a maximum deceleration constraint of the joint.

(16) The method of one of (14) or (15), wherein the number of time intervals further depends on one or more of a location or position of the joint, a velocity of the joint and a maximum admissible acceleration and jerk of the joint.

(17) The method of one of (1) to (16), wherein the state constraints comprise kinematic and dynamic constraints of the joint.

(18). A computer program having a program code for performing a method according to any one of (1) to (17), when the computer program is executed on a computer, a processor, or a programmable hardware component.

(19) An apparatus for controlling a plurality of joints of a robot comprising a control unit for performing one of the methods of (1) to (17).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. A method for controlling a plurality of joints of a robot based on a desired joint state, the method comprising
obtaining information on the desired joint state;
obtaining information on a current joint state;
filtering the desired joint state based on the information on the current joint state and based on state constraints of the robot to obtain information on a filtered desired joint state, wherein the filtered desired joint state complies to the state constraints; and
providing the information on the filtered desired joint states to control the joints of the robot.

2. The method of claim 1, wherein the filtering of the desired state is based on reducing a difference between the filtered desired state and the desired state considering the state constraints.

3. The method of claim 1, wherein the filtering is based on minimizing a difference between the filtered desired state and the desired state considering the state constraints.

4. The method of claim 3, wherein the difference is determined by a sum or a weighted sum of the differences between the desired joint state and the filtered desired joint state in terms one or more of location or position of the joint, a velocity of the joint, an acceleration of the joint, a jerk of the joint, and/or a higher order derivative of the location or position.

5. The method of claim 4, wherein the difference is a mean-square error or a weighted mean square error between the filtered desired state and the desired state considering the state constraints.

6. The method of claim 5, wherein the filtering comprises determining filter rules for each of the plurality of joints separately.

7. The method of claim 1, wherein the filtering is further based on avoiding an ultimate infeasible state of the robot.

8. The method of claim 7, wherein the avoiding of the ultimate infeasible state is based on analyzing an effect of a filtered desired jerk on future states.

9. The method of claim 1, wherein the filtering is further based on coupling effects between the joints of the robot and/or non-linear dynamics of the joints of the robot.

10. The method of claim 1, wherein the current, the desired and the filtered desired joint states comprise one or more of information on a location or position of the joint, a velocity of the joint, an acceleration of the joint, a jerk of the joint, and/or a higher order derivative of the location or position.

11. The method of claim 1, wherein
the current and the filtered desired joint states comprise information on a location or position of the joint, a velocity of the joint, an acceleration of the joint and a jerk of the joint, and
wherein the desired joint state comprises three or less elements of the group of information on a location on or position of the joint, a velocity of the joint, an acceleration of the joint and a jerk of the joint, and
wherein the method further comprises predicting a desired joint state for a subsequent time interval based on the current and the desired joint state, wherein the desired joint state for the subsequent time interval comprises predicted information on one or more elements of the group of a location or position of the joint, a velocity of the joint, an acceleration of the joint and a jerk of the joint, and
wherein the filtering is based on the predicted desired joint state for the subsequent time interval.

12. The method of claim 11, wherein the predicting of the desired joint state for the subsequent time interval comprises using a parametric state estimation based on the desired joint state to obtain the predicted desired joint state for the subsequent time interval.

13. The method of claim 12, wherein the parametric state estimation uses a Savitzky-Golay algorithm.

14. The method of claim 1, wherein the filtering is based on state constraints, which are based on a number of multiple subsequent time intervals.

15. The method of claim 14, wherein the number of subsequent intervals is configured to allow stopping a motion of a joint based on a maximum deceleration constraint of the joint.

16. The method of claim 15, wherein the number of time intervals further depends on one or more of a location or position of the joint, a velocity of the joint and a maximum admissible acceleration and jerk of the joint.

17. The method of claim 1, wherein the state constraints comprise kinematic and dynamic constraints of the joint.

18. A non-transitory computer readable medium storing a computer program having program code for performing the method according to claim 1, when the computer program is executed on a computer, a processor, or a programmable hardware component.

19. An apparatus for controlling a plurality of joints of a robot comprising a control unit for performing one of the method of claim 1.
